(19) United States
(12) Patent Application Publication
(10) Pub. No.: US 2008/0181130 A1
(43) Pub. Date: Jul. 31, 2008

(54) RECEIVER-BASED LINK-LAYER PROTOCOL

(75) Inventors: Shivashankar Balu, Bangalore (IN); Atish Datta Chowdhury, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/668,055

(22) Filed: Jan. 29, 2007

(51) Int. Cl. H04L 12/28

(52) U.S. Cl. 370/254

(57) ABSTRACT

In one embodiment, a system comprises a plurality of nodes. Each node comprises a transceiver to communicate with at least one of the other nodes over a communication medium. Each node has an associated logical, repeating time period, where each time period comprises a first portion in which the respective node is in a listen mode in which the respective node listens on the communication medium and a second portion in which the respective node is an inactive mode in which the respective node is operated in a low-power mode. When a sending node included in the plurality of nodes intends to transmit data via the communication medium to a destination node included in the plurality of nodes, the sending node attempts to transmit the data to the destination node via the communication medium when the destination node is in the listen mode.

### TECHNICAL FIELD

The following description relates to network technology in general and to a receiver-based link-layer protocol in particular.

### BACKGROUND

One type of wireless network is a wireless sensor network. In a wireless sensor network, two or more devices (also referred to here as “nodes”) communicate over wireless communication links (for example, over radio frequency (RF) communication links). One or more of the nodes in a wireless sensor network incorporate (or are otherwise coupled to) a sensor. Such nodes are also referred to here as “wireless sensor nodes” or “sensor nodes.” Each sensor is capable of generating or obtaining data that is indicative of some physical attribute of interest. Such data is also referred to here as “sensed data.”

In one application, an ad-hoc wireless sensor network is implemented using battery-powered wireless sensor nodes that cannot be recharged while deployed. As a result, it is typically desirable, in such an application, to reduce the amount power used by such wireless sensor nodes. However, in some ad-hoc wireless sensor networks that are implemented using a random-access based link-layer protocol, the battery-powered sensor nodes end up consuming as much power idling as when the nodes are involved in a wireless communication.

### SUMMARY

In one embodiment, a system comprises a plurality of nodes. Each node comprises a transceiver to communicate with at least one of the other nodes over a communication medium. Each node has an associated logical, repeating time period, where each time period comprises a first portion in which the respective node is in a listen mode in which the respective node listens on the communication medium and a second portion in which the respective node is an inactive mode in which the respective node is operated in a low-power mode. When a sending node included in the plurality of nodes intends to transmit data via the communication medium to a destination node included in the plurality of nodes, the sending node attempts to transmit the data to the destination node via the communication medium when the destination node is in the listen mode.

In another embodiment, a method communicates between a sending node and a receiving node over a communication medium. The method comprises, during a first portion of each of successive, repeating logical time periods associated with the receiving node, operating the receiving node in a listen mode in which the receiving node listens on the communication medium. The method further comprises, during a second portion of each of the successive, repeating logical time periods, operating the receiving node in an inactive mode in which the receiving node is operated in a low-power mode. The method further comprises attempting to transmit data on the communication medium from the sending node to the receiving when the receiving node is operating in the listen mode.

In another embodiment, a first node comprises a transceiver to communicate over a communication medium. During a first portion of each of successive, super frames associated with the first node, the first node is operated in a listen mode in which the first node listens on the communication medium. During a second portion of each of the super frames, the first node is operated in an inactive mode in which the first node is operated in a low-power mode.

The details of various embodiments of the claimed invention are set forth in the accompanying drawings and the description below. Other features and advantages will become apparent from the description, the drawings, and the claims.

### DRAWINGS

FIG. 1 is a block diagram of one embodiment of a wireless network.

FIG. 2 is a block diagram of one embodiment of a wireless node.

FIG. 3 illustrates a set of super frames used in an implementation of the wireless network of FIG. 1.

FIGS. 4A-4C are flow diagrams of one embodiment of a method of performing link-layer processing to send a unicast packet.

FIG. 5 is a flow diagram of one embodiment of a method of performing link-layer processing to send a broadcast packet.

FIGS. 6A-6E are flow diagrams of one embodiment of a method of performing link-layer processing to receive a packet.

FIG. 7 illustrates an example of the operation of one embodiment of a priority-based random back-off process.

FIG. 8 illustrates an example of messages exchanged between a sending node and a receiving node.

FIG. 9 illustrates a possible “starvation” scenario in the wireless network of FIG. 1.

FIG. 10 illustrates a possible “hidden terminal” scenario in the wireless network of FIG. 1.

Like reference numbers and designations in the various drawings indicate like elements.

### DETAILED DESCRIPTION

In the following description, embodiments of a receiver-based link layer protocol are described as being implemented in a wireless sensor network. It is to be understood, however, that the techniques, devices, systems, and methods described here can be implemented in other ways (for example, in other types of wired and/or wireless networks using other types of communication media).

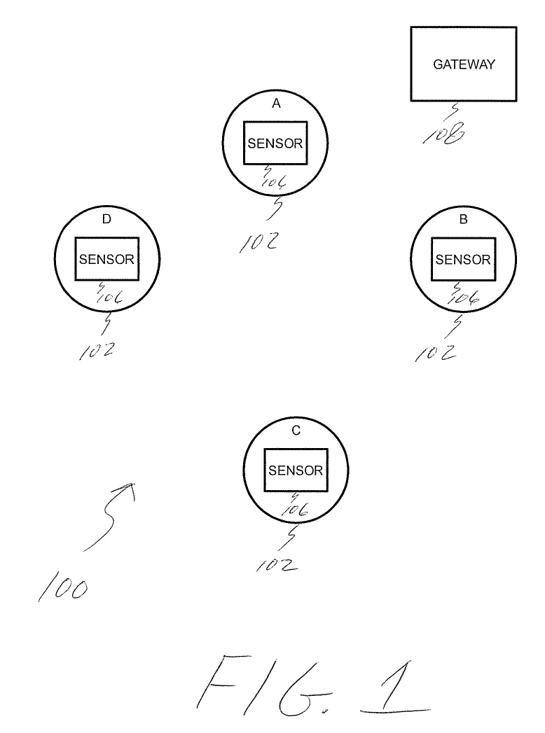

FIG. 1 is a block diagram of one embodiment of a wireless network 100. The wireless network 100 comprises a plurality of nodes 102, at least a portion of which communicate with one another over a wireless communication medium. In the particular embodiment shown in FIG. 1, at least a portion of the nodes 102 communicate with one another using radio frequency (RF) wireless communication links. In other embodiments, other types of wireless communication media (for example, infrared wireless communication links) are used instead of or in addition to RF wireless communication links. The nodes 102 of the network 100 are also individually labeled with the letters A through D and are individually referred to here as “node A,” “node B,” “node C,” and “node D.”

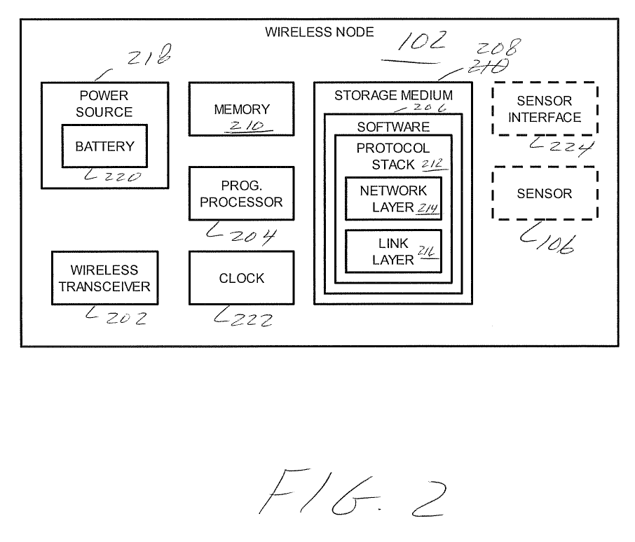

In the particular embodiment shown in FIG. 1, at least a portion of the nodes 102 are wireless sensor nodes and, as a result, network 100 is also referred to here as “wireless sensor network” 100. Each wireless sensor node includes (or is otherwise coupled to) a sensor 106. Each sensor 106 is capable of generating or obtaining sensor data that is indicative of some physical attribute of interest. Each wireless sensor node receives sensor data from a respective sensor 106 included in or otherwise coupled to that wireless sensor node. In one implementation of such an embodiment, each wireless sensor node is implemented using the battery-powered wireless sensor node described below in connection with FIG. 2.

In the embodiment shown in FIG. 1, the nodes 102 include at least one gateway node 108 that, in addition to communicating with one or more nodes 102 of the network 100, communicates with a network or device (not shown) external to the wireless network 100 (for example, using a wired or wireless communication link). In other words, the gateway node 108 acts as a gateway between the wireless network 100 and the other external network or device, forwarding data from the wireless network 100 to the external network or device and forwarding data from the external network or device to the wireless network 100.

In the embodiment shown in FIG. 1, the wireless sensor network 100 is implemented as an ad-hoc network using a suitable routing protocol. For example, in one implementation, the wireless sensor network 100 is implemented using a multi-hop routing protocol. Such a multi-hop routing protocol provides a mechanism for a packet (or other unit of data) to be transmitted by a source node to a destination node outside of the wireless transmission range of the source node by transmitting the packet to an intermediate node within the source node's wireless transmission range. The intermediate node then forwards the packet on to the destination node (if the destination node is within the intermediate node's wireless transmission range) or on to another intermediate node within the first intermediate node's wireless transmission range. This forwarding process is repeated until the packet reaches the destination node. For a given node, those nodes with which the given node is able to communicate directly without any hops are referred to here as the “neighbor nodes” or “neighbors” of the given node. Such a routing protocol, in one embodiment (for example, in the embodiment described below in connection with FIG. 2), is implemented in a network layer within each node 102.

In other embodiments, network 100 is implemented in other ways (for example, using other types of nodes and/or routing protocols).

FIG. 2 is a block diagram of one embodiment of a wireless node 102. The wireless node 102 shown in FIG. 2 is suitable for use in the embodiment of a wireless network 100 shown in FIG. 1. The wireless node 102 shown in FIG. 2 comprises a wireless transceiver 202 that transmits and receives data over one or more wireless communication links. In one embodiment, the wireless transceiver 202 comprises a RF transceiver that sends and receives data over one or more RF communication links. In other embodiments, the wireless transceiver 202 comprises other types of wireless transceivers for sending and receiving data over other types of wireless communication links (for example, an infrared transceiver for sending and receiving data over infrared communication links) instead of or in addition to an RF transceiver.

The wireless node 102 shown in FIG. 2 further comprises a programmable processor 204 that executes software 206. The software 206 comprises program instructions that, when executed by the programmable processor 204, perform at least a portion of the processing described here as being performed by the wireless node 102. The software 206 is stored (or otherwise embodied) on or in a storage medium 208 (for example, a read-only memory device or flash memory device) from which at least a portion of the software 206 is read by the processor 204 for execution thereby. The wireless node 102 shown in FIG. 2 includes memory 210 in which at least a portion of the software 206 and any data structures used by the software 206 are stored during execution. The memory 210 includes any appropriate type of memory now known or later developed including without limitation, ROM, random access memory (RAM), and a set of registers included within the processor 204. In the particular embodiment shown in FIG. 2, the software 206 comprises a protocol stack 212 that implements at least a portion of the functionality of the Open Systems Interconnect (OSI) protocol stack. In particular, the protocol stack 212 comprises at least a network layer 214 and a data link layer 216 (also referred to here as the “link layer” 216).

The wireless node 102 also comprises a power source 218. In the embodiment shown in FIG. 2, the power source 218 includes a battery 220. In one implementation of the node 102 shown in FIG. 2, the battery 220 of the wireless node 102 cannot be replaced or recharged while the wireless node 102 is deployed in the network 100. In other embodiments, the power source 218 comprises, in addition to or instead of a battery 220, an interface for coupling the wireless node 102 to an external power source such as a source of alternating current (AC) power. The wireless node 102 also comprises a clock 222. The clock 222 is used to provide timing information to the various components of the node 102.

Those nodes 102 that are implemented as wireless sensor nodes include the elements shown in FIG. 2 using dashed lines. Such a wireless sensor node comprises a sensor interface 224 that couples a sensor 106 to the wireless sensor node. In the particular embodiment shown in FIG. 2, the sensor 106 is integrated into the wireless sensor node (for example, by enclosing the sensor 106 within a housing that encloses the sensor 106 along with the other components of the wireless sensor node). In another embodiment, the sensor 106 is not integrated into the wireless sensor node but is otherwise communicatively coupled to the other components of the wireless sensor node via the sensor interface 224.

The sensor 106 is capable of generating or otherwise obtaining data that is indicative of some physical attribute of interest. Examples of sensors include, but are not limited to, devices that generate a value indicative of temperature, light, magnetic field, air flow, acceleration, vibration, sound, or power. The sensor interface 224 comprises appropriate interface hardware or software for communicatively coupling the sensor 106 to the other components of the wireless sensor node. For example, in one embodiment, the sensor interface 224 includes, for example, an analog-to-digital converter and/or a software driver for the sensor 106.

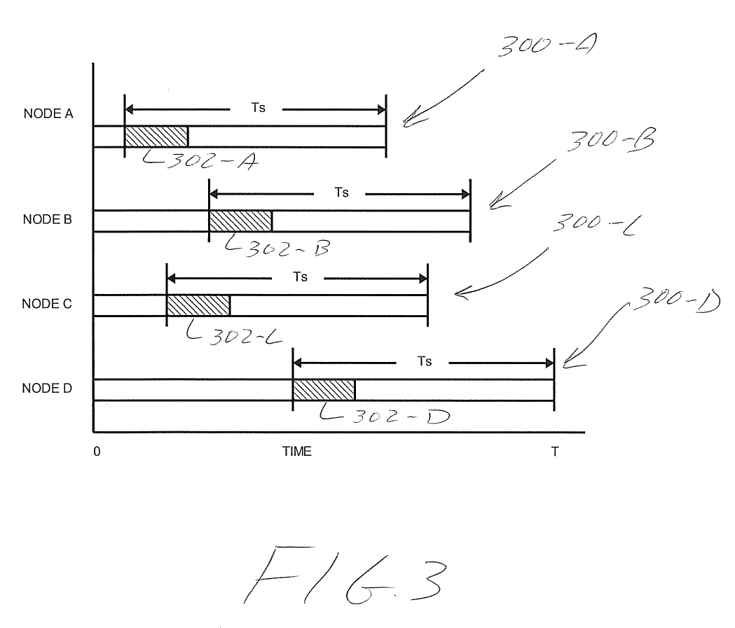

FIG. 3 illustrates a set of super frames 300 used in an implementation of the wireless network 100 of FIG. 1. As used herein, a “super frame” 300 is a repeating, logical period that is used here to define the link-layer processing that is performed by each node 102 in the wireless network 100. For example, in FIG. 3, the super frames 300 associated with each of the nodes A, B, C, and D are individually labeled in FIG. 3 as super frames 300-A, 300-B, 300-C, and 300-D, respectively. As shown in FIG. 3, each super frame 300 has a duration Tₛ. Each node u maintains vₜₛ, ∀ v ε N{u} where N{u}=>neighbors of u and where vₜₛ is the duration of the super frame 300 of the neighbor node v. In the particular example shown in FIGS. 3-6, the super frames 300 associated with each of the nodes 102 of the network 100 have the same duration Tₛ (that is, vₜₛ=Tₛ). In other embodiments, the duration Tₛ of the super frames can vary from node-to-node.

In the particular example shown in FIG. 3, each of the nodes 102 does not synchronize the local clock of that node 102 with the local clocks of the other node 102 in the network 100. Instead, each node 102 determines the difference between the start of that node's super frames 300 and the start of each of the other nodes' super frames 300. More formally, each node u maintains v_{d}, ∀ v ε N{u} where N{u}=>neighbors of u and where v_{d} is the difference between the start of u's super frames 300 and the start of the super frame 300 of neighbor v (which is also referred to here as the “drift” v_{d}).

In one embodiment, each node 102 periodically transmits information (also referred to here as “control information”) that is used by the other nodes 102 to determine vₜₛ and v_{d} for the transmitting node 102. In one example, such control information comprises the absolute time for that node 102 and the logical time relative to the start of the current super frame 300 for that node 102 and, in those embodiments where the duration Tₛ varies from node-to-node, the duration Tₛ of the super frame for the transmitting node 102.

Each node 102, at any given point in time during a particular super frame 300, is in one of three link-layer modes—a listen mode, a busy mode, and an inactive mode. When a node 102 is in the listen mode, the node 102 operates its transceiver 202 in a mode in which the transceiver 202 listens (that is, is available to receive) on a predefined frequency (also referred to here as the “default frequency”) for any packets (or other units of data). When a node 102 is in the busy mode, the node 102 is engaged in a data transfer (that is, is sending or receiving data over a wireless communication link). When a node 102 is in the inactive mode, the node 102 places the transceiver 202 in mode in which the transceiver 202 is powered off or otherwise placed in a power-saving state).

In the particular embodiment shown in FIG. 3, each node 102 operates in the listen mode 302 at the beginning of each super frame 300 for a particular amount of time (also referred to here as the “listen-mode time” Lₓ). In FIG. 3, the listen modes 302 associated with each of the nodes A, B, C, and D are individually labeled in FIG. 3 as listen mode 302-A, 302-B, 302-C, and 302-D, respectively.

Initially, when each node 102 (also referred to in this context as the “joining node” 102) joins the network 100 (for example, when the network 100 is first started or when a particular node 102 subsequently joins the network 100), the joining node 102 by default operates in the listen mode for the entire duration of each super frame 300 (that is, the listen-mode time Lₓ=100 percent). This is also referred to here as the “discovery phase” or “start-up phase” of operation. The joining node 102 also performs processing required to notify any neighbor nodes that the joining node 102 has joined the network 100 (for example, using a neighbor discovery protocol employed in the network 100). As a part of this processing, the joining node 102 also broadcasts its control information to its neighbor nodes 102 so that each of the neighbor nodes 102 can determine the drift vd for the joining node 102.

After the neighbor discovery protocol processing is complete, each node 102 operates in the listen mode for less than the entire duration of each super frame 300. This is also referred to here as the “normal phase” of operation. The listen-mode time Lₓ that is used for a particular node 102 while operating in the normal phase of operation is tunable. In one embodiment, all the nodes 102 in the network 100 use the same listen-mode time Lₓ when operating in the normal phase of operation. For example, in one such embodiment, a listen-mode time Lₓ of ten percent of the super frame 300 is used. In another embodiment, the listen-mode time Lₓ used by the nodes 102 while operating in the normal phase of operation varies from node 102 to node 102. By reducing the amount of time a node 102 operates in the listen mode, the amount of power consumed by that node 102 is reduced. Also, while in the normal phase of operation, each node 102 periodically transmits control information that is used by the transmitting node's neighbor nodes 102 to determine vₜₛ and v_{d} for the transmitting node 102.

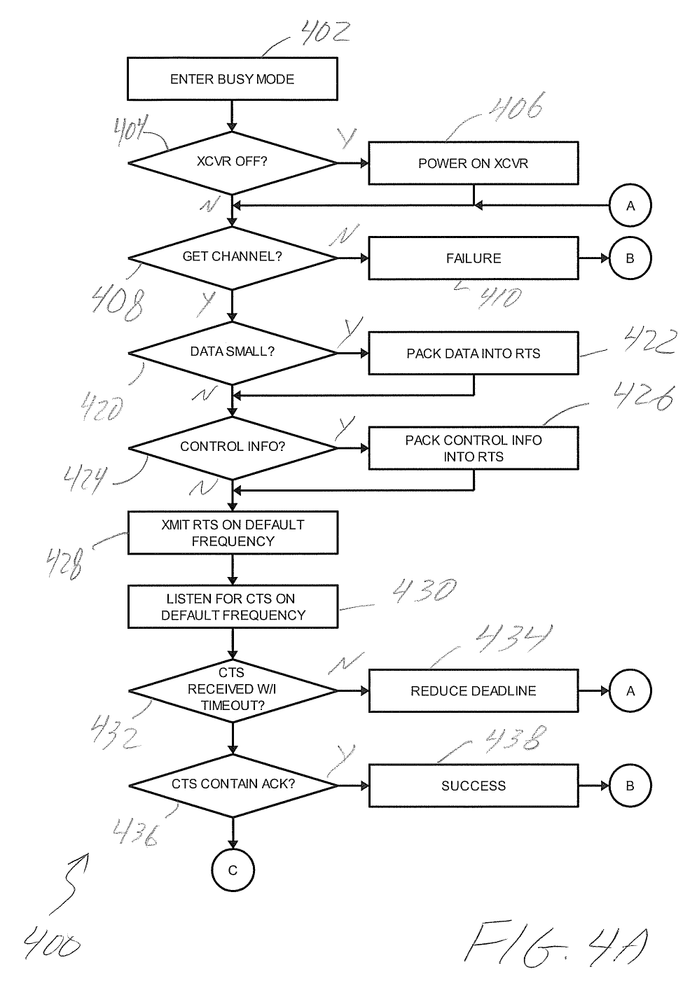

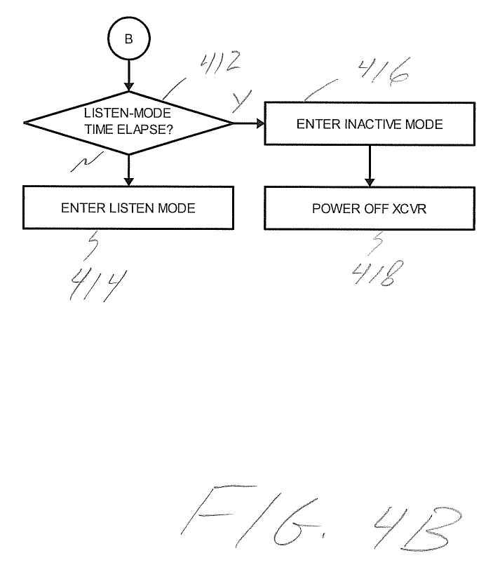

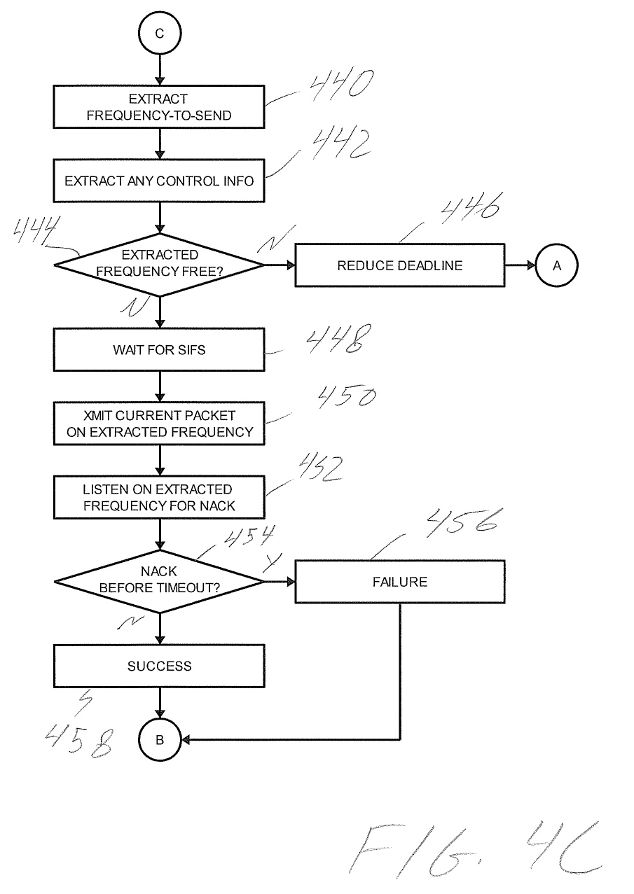

FIGS. 4A-4C are flow diagrams of one embodiment of a method 400 of performing link-layer processing to send a unicast packet. The particular embodiment of method 400 shown in FIGS. 4A-4C is described here as being implemented using the wireless sensor network 100 of FIG. 1 and the wireless node 102 of FIG. 2, though other embodiments are implemented in other ways. In such an embodiment, at least a portion of the processing described here in connection with method 400 is implemented in the link layer 216 of software 206 that is executed by the processor 204. In the context of FIGS. 4A-4C, the node 102 that is performing the processing of method 400 is referred to here as the “sending” node 102.

Method 400 is performed each time the network layer 214 of the sending node 102 causes the link layer 216 to send a unicast packet (also referred to here in the context of FIGS. 4A-4C as the “current packet”). When a unicast packet is to be transmitted, the network layer 214 of the sending node 102 determines if the destination node of the current packet is, at that time, in the listen mode. The network layer 214 of the sending node 102, in one implementation, makes this determination based on the local clock 222 of the sending node 102 and the super frame duration vₜₛ and drift information v_{d} for the destination node maintained at the sending node 102.

If the destination node of the current packet is in listen mode at the time the sending node 102 wishes to transmit the current packet, the network layer 214 of the sending node 102 causes the link layer 216 to attempt to send the current packet. If the destination node of the current packet is not in listen mode at the time the sending node 102 wishes to transmit the current packet, the network layer 214 of the sending node 102 schedules the current packet for transmission at a time when the destination node will be in listen mode and when the sending node 102 is not scheduled to transmit another packet. Before the network layer 214 causes the link layer 216 to attempt to transmit the current packet to the destination node, the network layer 214 computes a priority and a deadline for the current packet. The network layer 214 passes the priority and deadline values to the link layer 216 of the sending node 102 for use in the processing performed by the link layer 216. The priority value is used in a prioritized random back-off process performed by the link layer 216 of the sending node 102 if, when the link layer 216 of the sending node 102 attempts to transmit on a given frequency, another node 102 in the network 100 is attempting to transmit on that same frequency at the same time. The deadline value indicates for how long the link layer 216 of the sending node 102 should attempt to send the current packet. In one implementation of such an embodiment, the link layer 216 of the sending node 102 sets the deadline value for the current packet to the amount of time remaining in the destination node's current listen mode minus the time taken to transmit the packet.

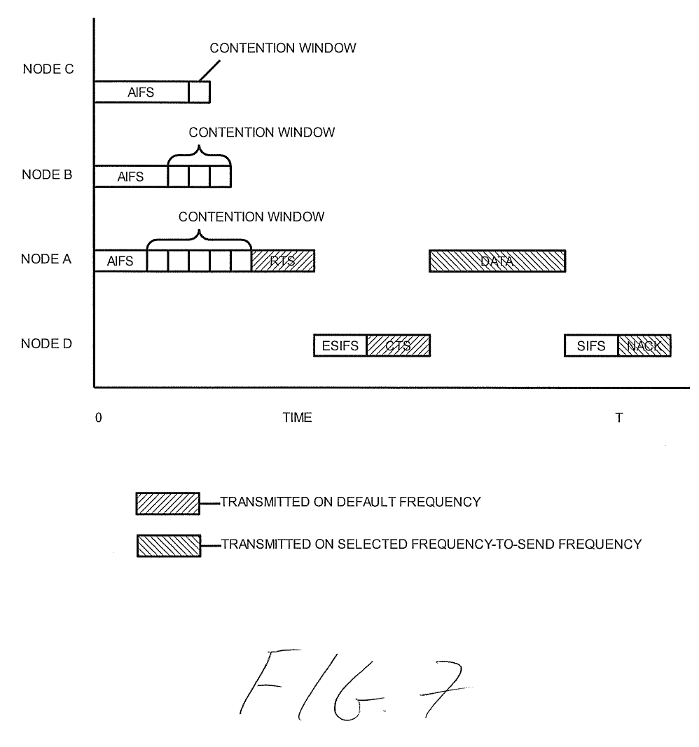

When the network layer 214 of the sending node 102 causes the link layer 216 to attempt to send the current packet, the sending node 102 enters the busy mode (block 402 of FIG. 4A) and, if the transceiver 202 of the sending node 102 is powered off (checked in block 404), the link layer 216 of the sending node 102 powers on the transceiver 202 (block 406). The link layer 216 of the sending node 102 then attempts to get a channel for transmitting the current packet (block 408). In the embodiment shown in FIGS. 4A-4C, the link layer 216 performs a prioritized Carrier Sense Multiple Access (CSMA) process in order to determine if the sending node 102 can transmit on the default frequency f_{d}. In the event that another node 102 is attempting to transmit on the default frequency f_{d} at the same time, the sending node 102 performs a prioritized-based random back-off process where the priority value for the current packet is used to determine the priority of the current packet. An example of such an approach is illustrated below in connection with FIG. 7. If the link layer 216 is unable to get a channel for transmitting the current packet (for example, because the deadline elapsed before the link layer 216 is able to access the default frequency f_{d}), the transmission of the current packet fails (block 410). Also, in such a case, if the listen-mode time Lₓ of the current super frame 300 for the sending node 102 has not elapsed (checked in block 412 of FIG. 4B), the sending node 102 enters the listen mode (block 414). Otherwise, if the listen-time mode Lₓ has elapsed, the sending node 102 enters the inactive mode (block 416) and powers off the transceiver 202 of the sending node 102 (or otherwise places the transceiver 202 into a power saving or low-power mode) (block 418).

In the particular embodiment shown in FIGS. 4A-4C, if the link layer 216 is able to get a channel for transmitting the current packet, the link layer 216 determines if the data contained in the current packet is “small” (block 420 of FIG. 4A). That is, the link layer 216 of the sending node 102 determines if the data contained in the current packet can fit within the payload of a request-to-send (RTS) message. If that is case, the data contained in the current packet is packed within an RTS message (block 422). Otherwise, if the data contained in the current packet is not small, the data contained in the current packet is not packed into the RTS message. It is to be understood, however, that in other embodiments such data packing is not performed.

Also, in the particular embodiment shown in FIGS. 4A-4C, if control information needs to be sent to the destination node (checked in block 424), the link layer 216 of the sending node packs the control information into the RTS message (block 426). For example, in one implementation, control information such as drift information, listen-mode time duration information, and/or super-frame duration information needs to be periodically sent to each node's neighbors. In such an implementation, when control information needs to be sent to the destination node for the current packet, the link layer 216 of the sending node 102 packs the control information into the RTS message. It is to be understood, however, that in other embodiments such control-information packing is not performed.

The link layer 216 then transmits the RTS message on the default frequency f_{d} (block 428). The RTS message also includes an estimate of an amount of time required to complete transfer. After transmitting the RTS message, the link layer 216 of the sending node 102 listens for a clear-to-send (CTS) message transmitted by the destination node 102 in response to the RTS message (block 430). The link layer 216 of the sending node 102 listens on the default frequency f_{d} for the CTS message. If a CTS message is not received within a predetermined CTS-timeout period (checked in block 432), the link layer 216 of the sending node 102 reduces the deadline for the current packet (block 434) and attempts to retransmit the current packet (looping back to block 408 of FIG. 4A). The deadline for the current packet is reduced by the amount of time it took to unsuccessfully attempt to transmit the current packet. If the amount of time originally specified in the deadline has elapsed (determined by the processing described above in connection with block 408 of FIG. 4A), the transmission of the current packet fails and the sending node 102 enters the listen mode or the busy mode, as appropriate.

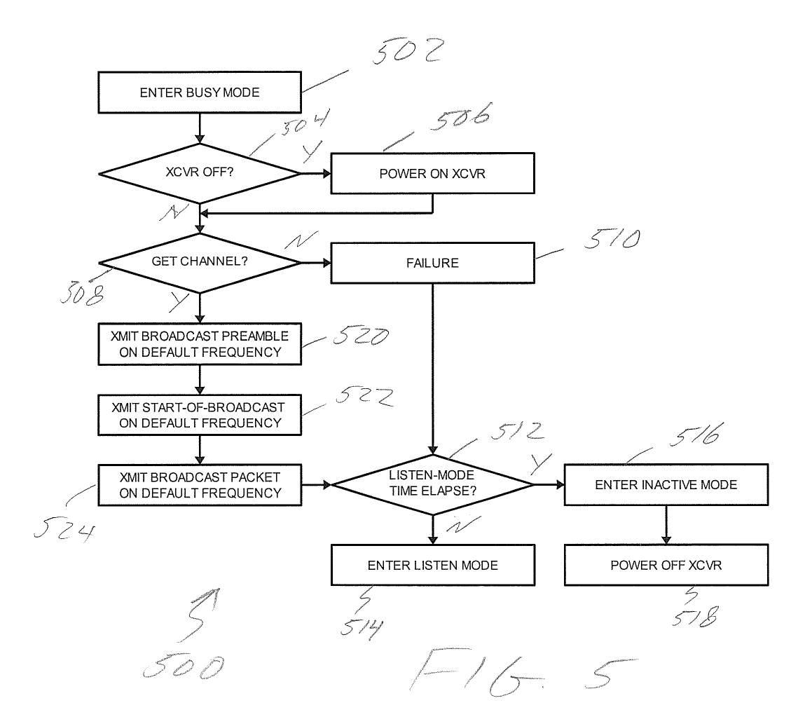

If a CTS message is received within the CTS-timeout period and the CTS message contains an acknowledgment (ACK) that any data packed into the RTS message was successfully received (checked in block 436), the transmission of the current packet is considered a success (block 438) and the sending node 102 enters the listen mode or the busy mode, as appropriate (looping back to block 412 of FIG. 4B). Otherwise, if a CTS message is received within the CTS-timeout period that does not contain an ACK, the link layer 216 extracts a frequency-to-send frequency f_{c} from the received CTS message (block 440 of FIG. 4C). In such an embodiment, the destination node to which the RTS message was sent, upon receiving the RTS message, selects the frequency-to-send frequency f_{c} and includes the frequency-to-send frequency f_{c} in the CTS message as described below in connection with FIG. 5. Also, in the particular embodiment shown in FIGS. 4A-4C, the link layer 216 of the sending node 102 extracts any control information that was packed into the received CTS message (block 442).

The link layer 216 of the sending node 102 tunes its transceiver 202 to the frequency-to-send frequency f_{c} extracted from the received CTS message and determines if that frequency f_{c} is free (checked in block 444). The link layer 216 of the sending node 102 performs an explicit carrier sensing in order to determine if the frequency-to-send frequency f_{c} is free (for example, to determine if there is a potential collision that the destination node 102 may not have been aware of at the time the destination node 102 selected the frequency-to-send frequency f_{c}). If the frequency-to-send frequency f_{c} is not free, the link layer 216 reduces the deadline for the current packet (block 446) and attempts to retransmit the current packet (looping back to block 408 of FIG. 4A) in the manner described above.

If the frequency-to-send frequency f_{c} is free, the link layer 216 of the sending node 102 waits for a short interframe space (SIFS) to allow for the transceiver 202 of the sending node 102 to switch from receiving mode to transmitting node (block 448 of FIG. 4C) and then transmits the current packet (block 450). After completing the transmission of the current packet, the link layer 216 of the sending node 102 listens for a negative acknowledgment (NACK) message on the frequency-to-send frequency f_{c} (block 452). If such a NACK message is received within a predetermined NACK-timeout period (checked in block 454), the transmission of the current packet fails (block 456) and the sending node 102 enters the listen mode or the busy mode, as appropriate (looping back to block 412 of FIG. 4). Otherwise, if no such NACK message is received within the NACK-timeout period, the transmission of the current packet is considered a success (block 458) and the sending node 102 enters the listen mode or the busy mode, as appropriate (looping back to block 412 of FIG. 4B).

FIG. 5 is a flow diagram of one embodiment of a method 500 of performing link-layer processing to send a broadcast packet. The particular embodiment of method 500 shown in FIG. 5 is described here as being implemented using the wireless sensor network 100 of FIG. 1 and the wireless node 102 of FIG. 2, though other embodiments are implemented in other ways. In such an embodiment, at least a portion of the processing described here in connection with method 500 is implemented in the link layer 216 of software 206 that is executed by the processor 204. In the context of FIG. 5, the node 102 that is performing the processing of method 500 is referred to here as the “broadcasting” node 102.

In the absence of globally synchronizing the super frames 300 used by all of the nodes 102 in the network 100, a packet might be broadcast from a broadcasting node 102 to all neighbors of the broadcasting node 102 by having the broadcasting node 102 perform a separate unicast transmission of that packet to each neighbor. In the embodiment shown in FIG. 5, method 500 avoids the need to synchronize all nodes 102 in the network 100 or to broadcast a packet using multiple unicast transmissions.

Method 500 is performed each time the network layer 214 of the broadcasting node 102 causes the link layer 216 to send a broadcast packet (also referred to here in the context of FIG. 5 as the “current packet”). When the network layer 214 causes the link layer 216 to broadcast a packet, the broadcasting node 102 enters the busy mode (block 502) and, if the transceiver 202 of the broadcasting node 102 is powered off (checked in block 504), the link layer 216 of the broadcasting node 102 powers on the transceiver 202 (block 506).

The link layer 216 of the broadcasting node 102 then attempts to get a channel for transmitting the current packet (block 508) in the manner described above in connection with block 408 of FIG. 4A. That is, the link layer 216 of the broadcasting node 102 performs a CSMA process in order to determine if the broadcasting node 102 can transmit on the default frequency f_{d}. If the link layer 216 is unable to get a channel for broadcasting the current packet (for example, because the deadline elapses before the link layer 216 is able to access the default frequency f_{d}), the broadcast of the current packet fails (block 510) and, if the listen-mode time Lₓ of the current super frame 300 for the broadcasting node 102 has not elapsed (checked in block 512), the broadcasting node 102 enters the listen mode (block 514). Otherwise, if the listen-time mode Lₓ has elapsed, the broadcasting node 102 enters the inactive mode (block 516) and powers off the transceiver 202 of the broadcasting node 102 (or otherwise places the transceiver 202 into a power saving or low-power mode) (block 518).

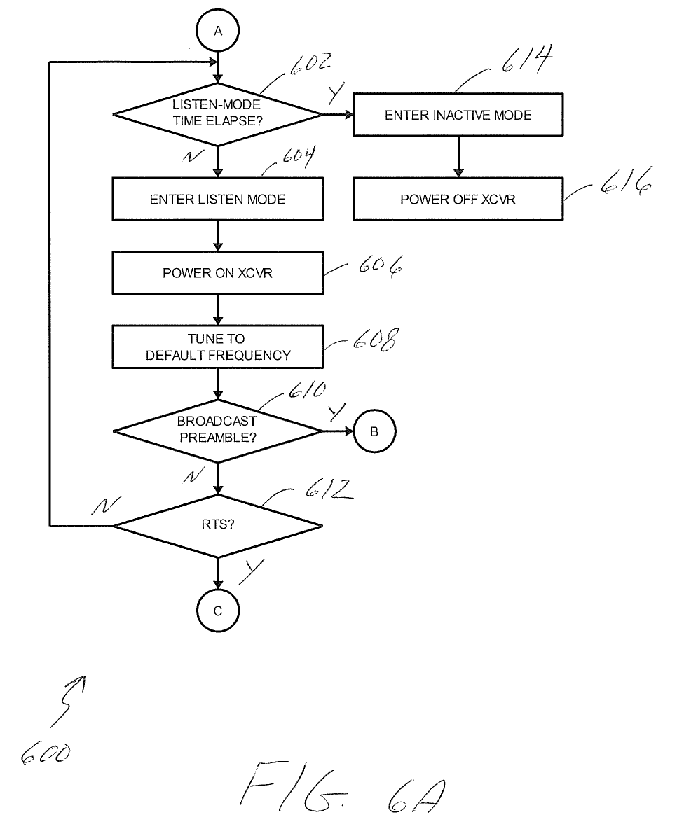

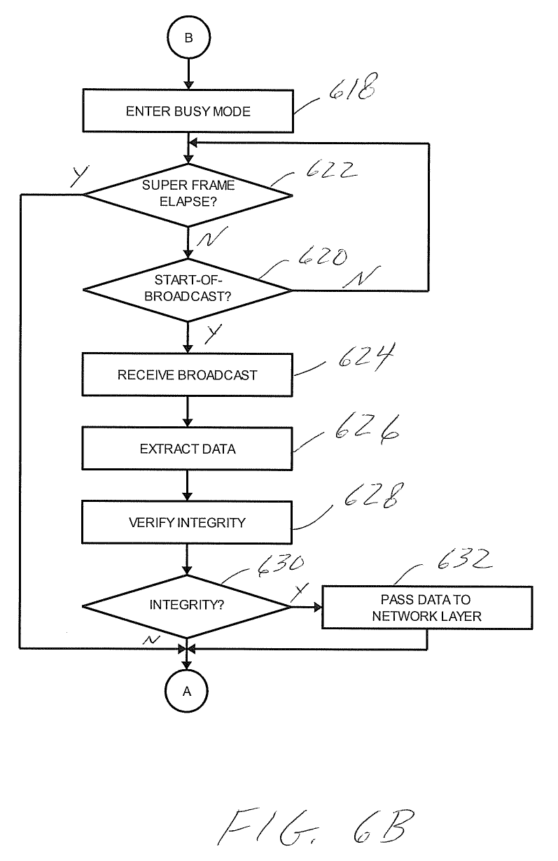

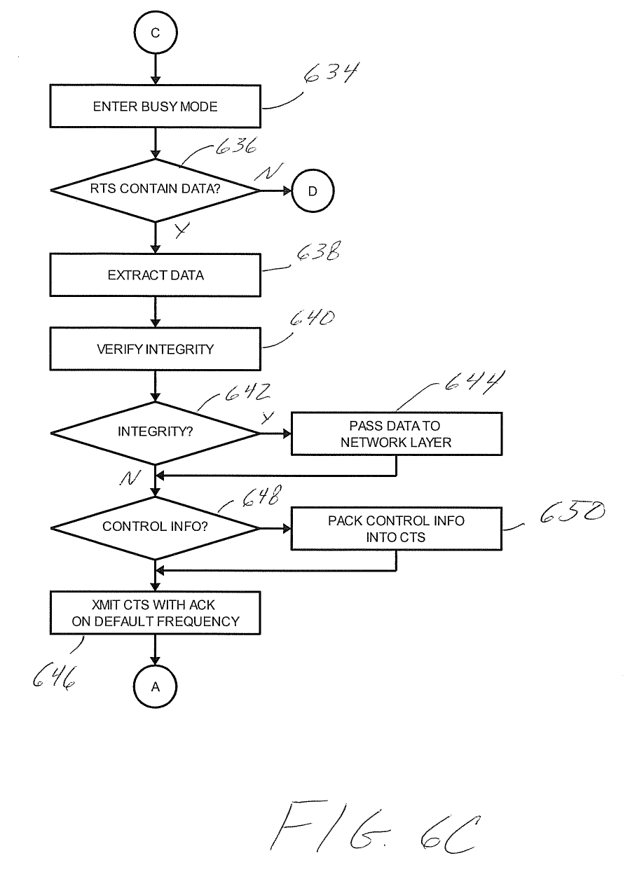

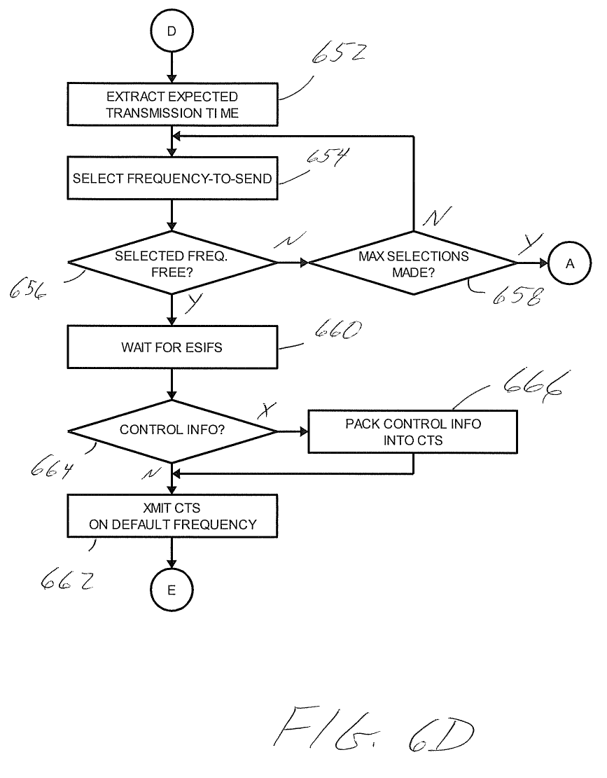

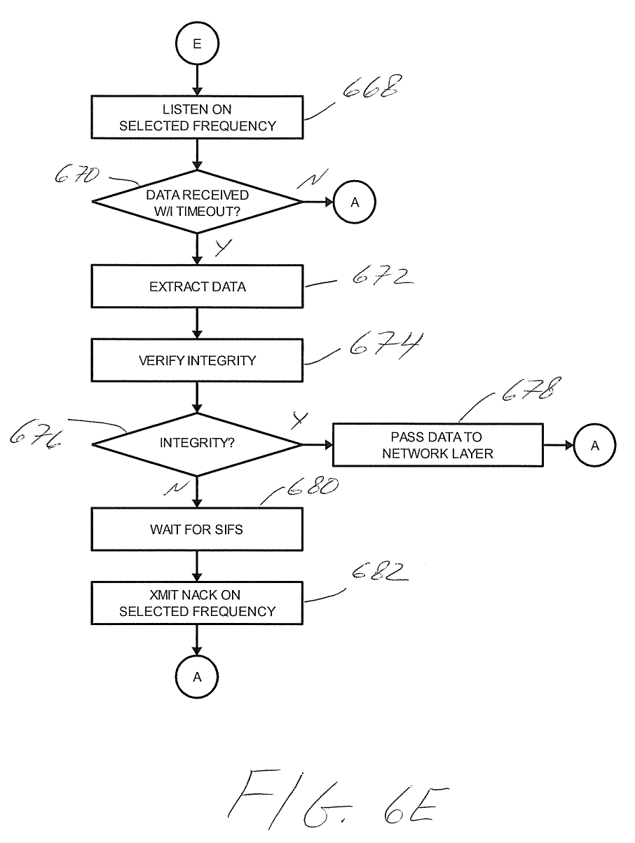

If the link layer 216 is able to get a channel for transmitting the current packet, the link layer 216 of the broadcasting node 102 transmits a broadcast preamble on the default frequency f_{d} for one complete super frame duration <Ts> (block 520). Any nodes 102 within transmission range of the broadcasting node 102 will, at some point during such preamble broadcast, be in the listen mode and recognize that the broadcasting node 102 is ready to broadcast (as described below in connection with FIGS. 6A-6E). Then, the link layer 216 of the broadcasting node 102 transmits a predefined start-of-broadcast frame on the default frequency f_{d} (block 522) and transmits the current packet on the default frequency f_{d} (block 524). Then, the broadcasting node 102 enters the listen mode or the busy mode, as appropriate (looping back to block 512).

The embodiment of method 500 shown in FIG. 5 provides a mechanism to broadcast a packet with a bounded latency of one super frame. That is, the broadcast preamble is broadcast for one super frame so that all the neighbors of the broadcasting node 102 will, at some point during the transmission of the broadcast preamble, be in the listen mode. Such neighbors, as a result, will receive the broadcast preamble and remain in the busy mode for up to one super frame in order to listen for the start-of-broadcast frame and the broadcast data transmission.

In an alternative embodiment, the broadcasting node 102 includes a node identifier and a scheduled broadcast time in a broadcast preamble that the broadcasting node 102 transmits. Each neighbor receives the broadcast preamble and extracts the scheduled broadcast time and node identifier. Each neighbor can then power off its transceiver 202 until the scheduled broadcast time identified in the broadcast preamble.

FIGS. 6A-6E are flow diagrams of one embodiment of a method 600 of performing link-layer processing to receive a packet. The particular embodiment of method 600 shown in FIGS. 6A-6E is described here as being implemented using the wireless sensor network 100 of FIG. 1 and the wireless node 102 of FIG. 2, though other embodiments are implemented in other ways. In such an embodiment, at least a portion of the processing described here in connection with method 600 is implemented in the link layer 216 of software 206 that is executed by the processor 204. In the context of FIGS. 6A-6E, the node 102 that is performing the processing of method 600 is referred to here as the “receiving” node 102.

Method 600 is performed by the receiving node 102 when that node 102 enters the listen mode (also referred to here in the context of FIGS. 6A-6E as the “current listen mode”) for a given super frame 300 (also referred to here in the context of FIGS. 6A-6E as the “current” super frame 300). For example, the receiving node 102 enters the listen mode at the beginning of the current super frame 300 or after exiting the busy mode after receiving, sending, or broadcasting a packet.

While the listen-mode time for the current super frame 300 has not elapsed (checked in block 602 of FIG. 6A), the receiving node 102 enters the listen mode (block 604) and the transceiver 202 of the sending node 102 is powered on (if the transceiver 202 was previously powered off) (block 606). The transceiver 202 of the receiving node 102 is also tuned to the default frequency f_{d} (block 608). The link layer 216 of the receiving node 102 then listens for a broadcast preamble (checked in block 610) or an RTS message (checked in block 612). When the listen-mode time for the current super frame 300 elapses, the receiving node 102 powers off the transceiver 202 (block 614) and enters the inactive mode (block 616).

When the link layer 216 of the receiving node 102 receives a broadcast preamble on the default frequency f_{d}, the receiving node 102 enters and thereafter remains in the busy mode (block 618 of FIG. 6B) until the link layer 216 receives a start-of-broadcast frame (checked in block 620) or until a full super-frame duration Tₛ has elapsed since the broadcast preamble was first received (checked in block 622). If a full super-frame duration Tₛ elapses without receiving a start-of-broadcast frame, the link layer 216 of the receiving node 102 loops back to block 602 of FIG. 6A. If the link layer 216 of the receiving node receives the start-of-broadcast frame before a full super-frame duration Tₛ has elapsed, the link layer 216 receives the broadcast message (block 624 of FIG. 6C) and extracts data from the received broadcast message (block 626). The link layer 216 of the receiving node 102 then verifies the integrity of the extracted data (for example, by performing a cyclic redundancy check (CRC) on the extracted data) (block 628). If the integrity check is successful (checked in block 630), the link layer 216 of the receiving node 102 passes the extracted data to the network layer 214 of the receiving node 102 for processing by the network layer 214 or higher layers (block 632) and loops back to block 602 of FIG. 6A. If the integrity check is unsuccessful, the link layer 216 of the receiving node 102 loops back to block 602.

When link layer 216 of the receiving node 102 receives an RTS message, the receiving node 102 enters the busy mode (block 634 of FIG. 6C). If the received RTS message contains data (checked in block 636), the link layer 216 of the receiving node 102 extracts the data (block 638) and verifies the integrity of the extracted data (for example, by performing a CRC on the extracted data) (block 640). If the integrity check is successful (checked in block 642), the link layer 216 of the receiving node 102 passes the extracted data to the network layer 214 of the receiving node 102 for processing thereby (block 644) and transmits a CTS message that includes an ACK on the default frequency f_{d} (block 646). The link layer 216 of the receiving node 102 then loops back to block 602 of FIG. 6A.

In the particular embodiment shown in FIGS. 6A-6E, if the integrity check is successful, any control information that needs to be sent from the receiving node 102 to the sending node (checked in block 648) is packed into the CTS message before the CTS message is transmitted (block 650). For example, in one implementation, control information such as drift information, listen-mode time duration information, and/or super-frame duration information needs to be periodically sent to each node's neighbors. In such an implementation, when such control information needs to be sent to the sending node 102 from the receiving node 102, the link layer 216 of the receiving node 102 packs the control information into the CTS message. It is to be understood, however, that in other embodiments such control-information packing is not performed.

If the integrity check is unsuccessful, a CTS message is not transmitted and the link layer 216 of the receiving node 102 loops back to block 602 of FIG. 6A. The node 102 that sent the received RTS message will then timeout after the CTS-timeout period elapses without receiving a CTS message (for example, as described above in connection with block 432 of FIG. 4A).

If the received RTS message does not contain data, the link layer 216 of the receiving node 102 extracts the expected transmission time from the received RTS message (block 652 of FIG. 6D) and randomly selects a frequency-to-send frequency f_{c} from a set of predetermined frequencies (block 654). The link layer 216 of the receiving node 102 checks if the selected frequency-to-send frequency f_{c} is free (block 656). If the selected frequency-to-send f_{c} is not free, the link layer 216 randomly selects another selected frequency-to-send f_{c} from the set of predetermined frequencies (looping back to block 654) unless the link layer 216 has made a predetermined maximum number of selections (checked in block 658). If the link layer 216 has made the maximum number of unsuccessful selections, a CTS message is not transmitted and the link layer 216 of the receiving node 102 loops back to block 602 of FIG. 6A. The node 102 that sent the received RTS message will then timeout after the CTS-timeout period elapses without receiving a CTS message (for example, as described above in connection with block 432 of FIG. 4A).

If the link layer 216 of the receiving node 102 successfully selects a frequency-to-send f_{c} frequency (that is, the selected frequency-to-send f_{c} frequency is free), the link layer 216 of the receiving node 102 waits for a short interframe space (also referred to here as the “eSIFS”) (block 660 of FIG. 6D) and then transmits, on the default frequency f_{d}, a CTS message that includes the selected frequency-to-send f_{c} frequency (block 662). In the particular embodiment shown in FIGS. 6A-6E, any control information that needs to be sent from the receiving node 102 to the sending node (checked in block 664) is packed into the CTS message before it is transmitted (block 666).

After transmitting the CTS message, the link layer 216 of the receiving node 102 listens on the selected frequency-to-send f_{c} frequency for a data transmission (block 668 of FIG. 6E) If a data transmission is not received within a predetermined data-timeout period (checked in block 670), the link layer 216 of the receiving node 102 loops back to block 602 of FIG. 6A without passing any data to the network layer 214 of the receiving node 102. If a data transmission is received within the data-timeout period, the link layer 216 of the receiving node 102 extracts data from the received transmission (block 672 of FIG. 6E). The link layer 216 of the receiving node 102 then verifies the integrity of the extracted data (for example, by performing a cyclic redundancy check (CRC) on the extracted data) (block 674). If the integrity check is successful (checked in block 676), the link layer 216 of the receiving node 102 passes the extracted data to the network layer 214 of the receiving node 102 for processing by the network layer 214 or higher layers (block 678) and loops back to block 602 of FIG. 6A.

If the integrity check is unsuccessful, the link layer 216 of the receiving node 102 waits for a short interframe space (SIFS) to allow for the transceiver 202 of the receiving node 102 to switch from receiving mode to transmitting node (block 680 of FIG. 6E) and then transmits a NACK message on the selected frequency-to-send f_{c} frequency (block 682). The link layer 216 of the receiving node 102 loops back to block 602 of FIG. 6A. The sending node 102 typically receives the NACK message and considers the transmission to be a failure (for example, as described above in connection with block 454 of FIG. 4C).

The link-layer processing shown in FIGS. 4-6 is especially well suited for use in wireless sensor networks 100 that include battery-powered sensor nodes that cannot be easily (if at all) recharged once deployed. Typically, such a battery-powered RF wireless sensor node consumes as much power in a conventional idle mode as when the node is transmitting or receiving. By sending data to a destination node 102 only when that destination node 102 is in listening mode, the amount of power consumed by such a sensor node can be significantly reduced. The average case per-hop latency with such an approach is upper-bounded by the duration of a super frame Tₛ.

In contrast to a quality-of-service-aware random-access protocol such as the Institute for Electrical and Electronics Engineers (IEEE) 802.11e standard, the methods 400 and 500 do not make use of a centrally coordinated allocation of contention-free periods and contention periods. Instead, in such methods, a priority-based random back-off process is used to get a channel in which high-priority packets are given priority over lower-priority packets. This process is typically used where more than one node 102 attempts to send data to the same destination node at the same time (for example, at the beginning of the destination node's next super frame. In such a situation, the priority-based random back-off process enables the highest-priority packet to be transmitted first during the listen mode of the current super frame 300 for the destination node while the lower-priority packets are either transmitted later during the listen mode of the current super frame 300 for the destination node or rescheduled for transmission during the next super frame 300.

An example of the operation of the priority-based random back-off process is shown in FIG. 7. In the example shown in FIG. 7, nodes A, B, and C all wish to transmit to node D and are scheduled by their respective network layers 214 to transmit at the beginning of node D's next super frame. FIG. 7 is illustrated relative to the next super frame of node D.

In this example, node A's transmission is assigned a first priority level, node B's transmission is assigned a second priority level, and node C's transmission is assigned a third priority level, where the first priority level is higher than the second priority level and the second priority level is higher than the third priority. In such an embodiment, each transmitting node (nodes A, B, and C in the example shown in FIG. 7) uses both a priority-based idle time (also referred to here as the “Arbitration Inter Frame Space” or “AIFS”) and a priority-based back-off counter (also referred to here as the “contention window”).

Each of the transmitting nodes selects an AIFS based on the priority value assigned to the particular transmission so that transmissions having a higher priority will be assigned a shorter AIFS than transmissions having a lower priority and transmissions having the same priority will be assigned the same AIFS. The priority-based contention window for each transmission is randomly chosen from a range that is specified for each priority. In one implementation, each contention window is specified as a number of slots, where each slot has a predetermined, fixed duration.

In the example shown in FIG. 7, the AIFS used for node A's transmission is shorter than the AIFS used for node B's transmission, and the AIFS used for node B's transmission is shorter than the AIFS used for node C's transmission. Also, in the example shown in FIG. 7, node A's link layer 216 computes a contention window for node A's transmission by randomly selecting from a range specified for the first priority level (for example, a number that is greater than or equal to 0 and less than 6) and multiplying the selected number by the slot duration. Node B's link layer 216 computes a contention window for node B's transmission by randomly selecting a range specified for the second priority level (for example, a number that is greater than or equal to 6 and less than 11) and multiplying the selected number by the slot duration. Node C's link layer 216 computes a contention window for node C's transmission by randomly selecting a range specified for the third priority level (for example, a number that is greater than or equal to 11 and less than 16) and multiplying the selected number by the slot duration. Consequently, as shown in FIG. 7, node A transmits its higher-priority transmission during the current super frame 300 while nodes B's and node C's wait to transmit later (until the deadlines specified for the respective transmissions elapse).

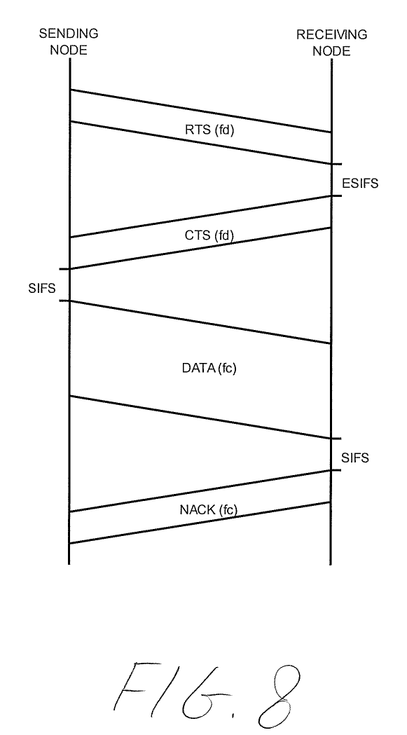

As shown in FIG. 7, node A transmits an RTS message on the default frequency f_{d}. Node D receives the RTS message transmitted by node A on the default frequency f_{d}, selects a frequency-to-send frequency f_{c}, and waits for an eSIFS while the transceiver 202 of node D switches from receiving mode to transmitting mode. Then, node D transmits a CTS message on the default frequency f_{d}. Node A receives the CTS message transmitted by node D, extracts the frequency-to-send frequency f_{c}, and then initiates a data transmission using the selected frequency-to-send frequency f_{c}. Node D receives the data transmission, checks the integrity of the received data, and, if necessary, transmits a NACK message on the selected frequency-to-send frequency f_{c} after waiting for a SIFS while the transceiver 202 of node D switches from the receiving mode to the transmitting mode. FIG. 8 also illustrates such message exchange between node A and node D.

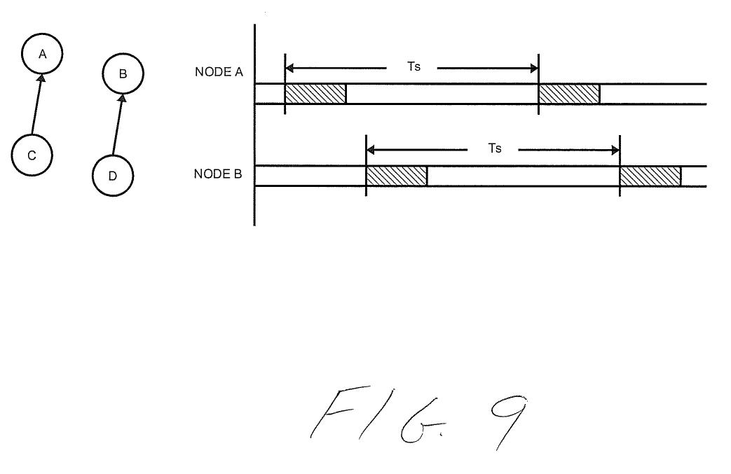

FIG. 9 illustrates a possible “starvation” scenario in the wireless network 100 of FIG. 1. In the absence of the dynamic frequency-to-send frequency f_{c} selection described above in connection with FIG. 6, where a periodic listening scheme is used, it is possible for two nodes 102 to always fail to communicate because of continual periodic data transmissions between other nodes 102 in the network 100. Such a scenario is also referred to here as “starvation.” In the example shown in FIG. 9, node C continuously makes a periodic data transmission to node A and node D continuously makes a periodic data transmission to node B (as shown by the arrow from node C to node A and the arrow from node D to node B). Also shown in FIG. 9 are the respective listen-mode times for nodes A and node B (shown with shading). In the example shown in FIG. 9, the listen mode of node A always starts before the listen mode of node B. Therefore, node C will always successfully start transmitting its periodic data to node A, in which case node D would always find the communication medium to be busy (assuming all the nodes 102 are within each other's transmission and reception range). As a result, the transfer from node D to node B will be starved for the duration of the periodic data transmission from node C to node A.

With the use of the dynamic frequency-to-send frequency f_{c} selection described above in connection with FIG. 6, such a starvation scenario will likely be avoided. When node C transmits data to node A on the frequency-to-send frequency f_{c}, node D will have a greater chance of finding the default frequency f_{d} to be free when node D attempts to transmit an RTS message to node B. Moreover, node B will also have a greater chance of ultimately selecting a free frequency-to-send frequency f_{c} for the data transmission between node D and node B.

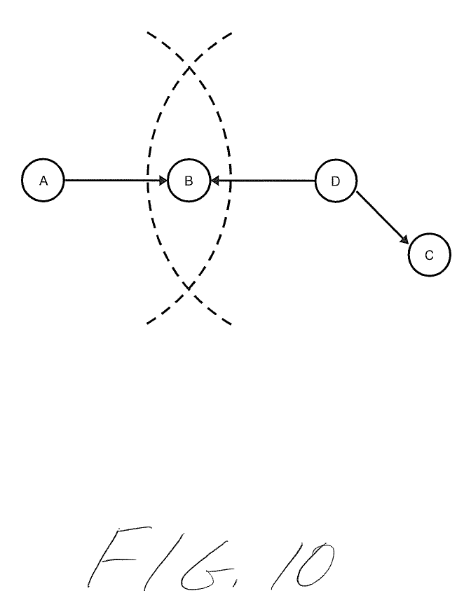

FIG. 10 illustrates a possible “hidden terminal” scenario in the wireless network 100 of FIG. 1. Each of the nodes 102 have a fixed transmission range beyond which that node's transmission cannot be received by other nodes 102. In the example shown in FIG. 10, node B is at the periphery of the transmission ranges of both node A and node D. Thus, it is possible for both nodes A and D to sense the channel as free and simultaneously both transmit to node B, resulting in collision at node B. This is referred to as the “hidden terminal” problem because node D is hidden from node A and node D is hidden from node A. As a result, node A is not able to sense the transmission from node D to node B and node D is not able sense the transmission from node A to node B. Conventional approaches to addressing this problem make use of special control messages—namely, RTS and CTS messages. In such approaches, before sending a data packet a sending node sends an RTS message. The receiving node, upon receiving the RTS message, sends a CTS message. Upon receiving the CTS message, the sending node transmits the data packet. The RTS and CTS messages will notify the neighbors of the sending and receiving nodes, that otherwise might be hidden from one of those nodes, of the pending transmission. Such neighbors, upon receiving an RTS and/or CTS message, will not transmit during the on-going transmission.

Such a conventional approach, however, is unsuitable for use in the embodiment of methods 400, 500, and 600 shown in FIGS. 4-6, respectively. This is because the nodes 102 in the network 100 are periodically inactive and may not receive such RTS and CTS messages transmitted by other nodes 102, unless the nodes 102 in the network 100 are globally synchronized so that their respective super frames begin at the same time.

Instead, in the embodiment of methods 400, 500, and 600 shown in FIGS. 4-6, respectively, a receiving node 102, upon receiving an RTS message, randomly selects a frequency-to-send frequency f_{c} from a set of predetermined frequencies and then checks if the selected frequency-to-send frequency f_{c} is free. If the frequency-to-send frequency f_{c} is free, the receiving node 102 sends a CTS message to the node 102 that transmitted the RTS message that includes the selected frequency-to-send frequency f_{c}. If the selected frequency-to-send frequency f_{c} is not free, the receiving node 102 selects another frequency-to-send frequency f_{c}. The selection process is repeated until a free frequency-to-send frequency f_{c} has been selected or until the number of selections exceeds the maximum selection limit.

In such an embodiment, a node D that was hidden from node A might still attempt to start a data transmission while node A is transmitting to node B. However, node D would start its transmission by transmitting an RTS message on the default frequency f_{d} while the data transmission by node A would occur on a selected frequency-to-send frequency f_{c} that is different from the default frequency f_{d}. In another scenario, node D transmits data to node C while at the same time node A transmits data to node B. If either node C or node D is within the transmission range of node A, the data transmission between node D and node C will not collide with the data transmission between node A and node B. That is, if node C is able to sense the data transmission from node A to node B, node C will select a frequency-to-send frequency f_{c} other than the selected frequency-to-send frequency f_{c} on which node A transmits data to node B. If node D is able to sense the data transmission from node A to node B when node D checks if the selected frequency-to-send frequency f_{c} contained with the CTS message is free, node D will not initiate the data transmission on that frequency-to-send frequency f_{c}. If neither node C nor node D is within the transmission range of node A, there is a chance that the selected frequency-to-send frequency f_{c} on which node A transmits data to node B will be the same as the selected frequency-to-send frequency f_{c} on which node D transmits data to node C. However, since both such frequency-to-send frequencies f_{c} are randomly selected, the chance that such frequencies will be the same will be relatively low.

In some embodiments, the higher layer protocols in the protocol stack 212 of a node 102 (for example, the application layer and/or the network layer 214) may cause the link layer 216 of a particular node 102 to not participate in any data transfers (that is, the receiving or transmission of data) for a particular period of time. In one example, the higher layer protocols may wish to perform a computation-intensive task that requires no communication or may wish to save additional energy for a period of time. In such an embodiment, the node 102 increases the duration of its super frame 300 so that the node 102 is the inactive mode for the desired amount of time. The node 102 informs its neighbors by transmitting control information that identifies the new, longer super frame duration. The neighbors of that node 102 will receive the control information and adjust the super frame duration value vₜₛ that the neighbors maintain and use for that node 102. In this way, the node 102 can achieve its desired objective (for example, performing a computation-intensive task or saving energy) while still maintaining an average-case bounded delay for transmissions in the network 100. Subsequently, that node 102 reduces its super frame duration back to its original super frame duration and sends appropriate control information to the node's neighbors, which update the vₜₛ information they maintain for that node.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system comprising:
a plurality of nodes, each node comprising a transceiver to communicate with at least one of the other nodes over a communication medium;
wherein each node has an associated logical, repeating time period, wherein each time period comprises a first portion in which the respective node is in a listen mode in which the respective node listens on the communication medium and a second portion in which the respective node is an inactive mode in which the respective node is operated in a low-power mode;
wherein when a sending node included in the plurality of nodes intends to transmit data via the communication medium to a destination node included in the plurality of nodes, the sending node attempts to transmit the data to the destination node via the communication medium when the destination node is in the listen mode.

2. The system of claim 1, wherein each node comprises a respective wireless transceiver for communicating over a wireless communication medium.

3. The system of claim 2, wherein each node comprises a respective radio frequency transceiver for communicating over a radio frequency wireless communication medium.

4. The system of claim 2, wherein at least a subset of the nodes are coupled to a sensor.

5. The system of claim 1, wherein at least a subset of the nodes are battery-powered.

6. The system of claim 1, wherein the respective logical, repeating time period associated with each node varies from node to node.

7. The system of claim 1, wherein the respective logical, repeating time period associated with at least one node varies from period to period.

8. The system of claim 1, wherein for at least one node, the respective transceiver is powered off when that node is operated in the lower-power mode.

9. The system of claim 1, wherein when the sending node attempts to transmit the data to the destination node, the sending node:
checks the communication medium to determine if a first frequency is free;
if the first frequency is free, transmits a first message to the destination node via the communication medium on the first frequency;
listens for a second message on the communication medium on the first frequency;
if the sending node receives the second message from the communication medium on the first frequency within a first timeout period since transmitting the first message:
extracts information indicative of a second frequency;
checks the communication medium to determine if the second frequency is free; and
if the second frequency is free, transmits the data to the destination node via the communication medium on the second frequency.

10. The system of claim 9, wherein the sending node selectively packs at least one of control information and the data into the first message.

11. The system of claim 9, wherein the destination node selectively packs control information into the second message.

12. The system of claim 9, wherein the first message comprises a ready-to-send message and the second message comprises a clear-to-send message.

13. The system of claim 9, wherein the plurality of nodes use a priority-based random-backoff process to control access to the communication medium, wherein the sending node uses the priority-based random-backoff process and a priority associated with the data to be transmitted in order to at least one of: check the communication medium to determine if the first frequency is free and check the communication medium to determine if the second frequency is free.

14. The system of claim 9, wherein the sending node considers the transmission of the data to be a failure if, after transmitting the data via the communication medium on the second frequency, the sending node receives a negative acknowledgement message from the destination node within a second timeout period since transmitting the data on the second frequency.

15. The system of claim 1, wherein each time period associated with each node comprises a super frame.

16. The system of claim 15, wherein when a broadcast node included in the plurality of nodes wishes to broadcast broadcast data to the other nodes, the broadcasting node:
checks the communication medium to determine if a first frequency is free; and
if the first frequency is free:
transmits a broadcast preamble for the duration of one super frame via the communication medium on the first frequency;
thereafter, transmits a start-of-broadcast frame via the communication medium on the first frequency; and
thereafter, transmits the broadcast data via the communication medium on the first frequency.

17. The system of claim 1, wherein when the destination node is in the listen mode for a respective logical period, the destination node:
when the first portion of the respective logical period has elapsed, causes the destination node to enter the inactive mode;
listens on the communication medium on a first frequency for a ready-to-send message;
when a ready-to-send message is received:
selects a second frequency from a set of predetermined frequencies;
checks the communication medium to determine if the selected second frequency is free;
if the selected second frequency is free:
transmits a clear-to-send message on the first frequency, wherein the clear-to-send message includes information indicative of the selected second frequency;
listens for transmission of the data via the communication medium on the second frequency; and
if the destination node receives the data on the communication medium on the second frequency within a predetermined timeout period since transmitting the clear-to-send message, verifies integrity of the data received by the destination node.

18. The system of claim 17, wherein when the destination node is in the listen mode for a respective logical period, the destination node:
listens on the communication medium on the first frequency for a broadcast preamble;
when the destination node receives the broadcast preamble:
if the destination node receives a start-of-broadcast frame within one instance of the logical, repeating time period associated with the destination node:
receives the broadcast data on the communication medium on the first frequency; and
verifies the integrity of the received broadcast data.

19. A method of communicating between a sending node and a receiving node over a communication medium, the method comprising:
during a first portion of each of successive, repeating logical time periods associated with the receiving node, operating the receiving node in a listen mode in which the receiving node listens on the communication medium;
during a second portion of each of the successive, repeating logical time periods, operating the receiving node in an inactive mode in which the receiving node is operated in a low-power mode; and
attempting to transmit data on the communication medium from the sending node to the receiving when the receiving node is operating in the listen mode.

20. The method of claim 19, wherein attempting to transmit data on the communication medium from the sending node to the receiving node when the receiving node is operating in the listen mode comprises:
checking the communication medium to determine if a first frequency is free;
if the first frequency is free, transmitting a first message from the sending node to the receiving node via the communication medium on the first frequency;
listening at the sending node for a second message on the communication medium on the first frequency; and
if the sending node receives the second message within a first timeout period since transmitting the first message:
extracting from the first message, at the sending node, information indicative of a second frequency;
checking the communication medium, at the sending node, to determine if the second frequency is free; and
if the second frequency is free, transmitting the data from the sending node to the receiving node via the communication medium on the second frequency.

21. The method of claim 20, further comprising selectively packing, at the sending node, at least one of: control information and the data into the first message.

22. The method of claim 20, further comprising selectively packing, at the receiving node, control information into the second message.

23. The method of claim 20, wherein the sending node and receiving node are included in a plurality of nodes, wherein each of the plurality of nodes use a priority-based random-backoff process to control access to the communication medium, wherein the sending node uses the priority-based random-backoff process and a priority associated with the data to be transmitted in order to at least one of: check if the first frequency is free and check if the second frequency is free.

24. The method of claim 20, considering the transmission of the data to be a failure if, after transmitting the data on the second frequency, the sending node receives a negative acknowledgement message from the receiving node within a second timeout period since transmitting the data on the second frequency.

25. The method of claim 19, wherein each time period associated with each node comprises a super frame.

26. The method of claim 25, further comprising broadcasting broadcast data from the sending node on the communication medium by:
checking the communication medium, at the sending node, to determine if a first frequency is free; and
if the first frequency is free:
transmitting, from the sending node, a broadcast preamble for the duration of one super frame via the communication medium on the first frequency;
thereafter, transmitting, from the sending node, a start-of-broadcast frame via the communication medium on the first frequency; and
thereafter, transmitting, from the sending node, the broadcast data via the communication medium on the first frequency.

27. The method of claim 19, wherein when the receiving node is operating in the listen mode for a respective current logical period:
causing the destination node to enter the inactive mode when the first portion of the respective current logical period has elapsed;
listening on the communication medium on a first frequency for a ready-to-send message;
when a ready-to-send message is received at the receiving node:
selecting a second frequency from a set of predetermined frequencies;
checking the communication medium to determine if the selected second frequency is free;
if the selected second frequency is free:
transmitting a clear-to-send message from the receiving node via the communication medium on the first frequency, wherein the clear-to-send message includes information indicative of the selected second frequency;
listening at the receiving node for transmission of the data on the communication medium on the second frequency; and
if the receiving node receives the data on the communication medium on the second frequency within a predetermined timeout period since transmitting the clear-to-send message, verifying integrity of the data received by the receiving node.

28. A first node comprising:
a transceiver to communicate over a communication medium;
wherein, during a first portion of each of successive, super frames associated with the first node, the first node is operated in a listen mode in which the first node listens on the communication medium; and
wherein, during a second portion of each of the super frames, the first node is operated in an inactive mode in which the first node is operated in a low-power mode.

29. The first node of claim 28, wherein the transceiver is operable to communicate with a second node over the communication medium, wherein the second node attempts to transmit data on the communication medium to the first when the first node is operating in the listen mode.

30. The first node of claim 29, wherein, during a first portion of each of successive, super frames associated with the second node, the second node is operated in a listen mode in which the second node listens on the communication medium;
wherein, during a second portion of each of the super frames associated with the second node, the second node is operated in an inactive mode in which the second node is operated in a low-power mode;
wherein the first node attempts to transmit data on the communication medium to the second node when the second node is operating in the listen mode.

31. The first node of claim 28, further comprising a programmable processor to execute a protocol stack, wherein the protocol stack comprises a link layer that is operable to cause the first node to operate in the listen mode during the first portion of each super frame and to operate in the inactive mode during the second portion of each super frame.

32. The first node of claim 31, wherein the protocol stack further comprises a network layer that defines at least one of a priority and deadline for the data.

33. The first node of claim 28, wherein the transceiver comprises a wireless transceiver for communicating over a wireless communication medium.

34. The first node of claim 33, wherein the wireless transceiver comprises a radio frequency wireless transceiver for communicating over radio frequency wireless communication medium.

35. The first node of claim 28, further comprising a sensor interface to couple a sensor to the first node.

36. The first node of claim 28, further comprising a battery to power at least the transceiver.

37. The first node of claim 28, wherein the transceiver is powered off when the first node is operated in the lower-power mode.

38. Software comprising program instructions embodied on a storage medium, wherein the program instructions are operable to cause a programmable processor of a first node to:
operate the first node in a listen mode in which the first node listens on a communication medium during a first portion of each of successive, repeating logical time periods associated with the first node; and
operate the first node in an inactive mode in which the first node is operated in a low-power mode during a second portion of each of the successive, repeating logical time periods.

39. The software of claim 38, wherein the first node communicates with a second node over the communication medium, wherein the second node attempts to transmit data on the communication medium to the first when the first node is operating in the listen mode.

40. The software of claim 39, wherein, during a first portion of each of repeating logical time periods associated with the second node, the second node is operated in a listen mode in which the second node listens on the communication medium;
wherein, during a second portion of each of the successive, repeating logical time periods associated with the second node, the second node is operated in an inactive mode in which the second node is operated in a low-power mode; and
wherein the software is operable to cause the programmable to cause the first node to attempt to transmit data on the communication medium to the second when the second node is operating in the listen mode.

41. The software of claim 38, wherein the software comprises a protocol stack, wherein the protocol stack comprises a link layer that is operable to cause the first node to operate in the listen mode during the first portion of each of the successive, repeating logical time periods and to operate in the inactive mode during the second portion of each of the successive, repeating logical time periods.

42. The node of claim 41, wherein the protocol stack further comprises a network layer that defines at least one of a priority and deadline for the data.

43. A first node comprising:
a transceiver means for communicating over a communication medium;
means for operating the first node in a listen mode in which the first node listens on a communication medium during a first portion of each of successive, repeating logical time periods associated with the first node; and
means for operating the first node in an inactive mode in which the first node is operated in a low-power mode during a second portion of each of the successive, repeating logical time periods.
